(19) United States
(12) Patent Application Publication
(10) Pub. No.: US 2006/0054762 A1
(43) Pub. Date: Mar. 16, 2006

(54) Drape opener for sliding door

(76) Inventor: Qamar A. Shafeek, Indianapolis, IN (US)

Correspondence Address: William M. Selenke, 5 Drummond St., Cincinnati, OH, 45218, US

(21) Appl. No.: 11/217,231

(22) Filed: Sep. 1, 2005

Related U.S. Application Data
(60) Provisional application No. 60/608,731, filed on Sep. 10, 2004.

(51) Int. Cl. F16B 45/00

(52) U.S. Cl. 248/304

(57) ABSTRACT

The drapery opener hook device has a journal with an attachment end and a hook end. The attachment end is affixed with squeeze pressure points to a flat attachment base. The flat attachment base, in turn is affixed to the workpiece door. The hook end of the journal has a first bend and a second bend to create a square base hook. The square base hook has a rotational sleeve made of one or more independent sections to allow the ready movement of the drape over the square base hook. The attachment base has pressure points as attachment means to attach the journal to the flat attachment base. The attachment base has holes to receive screws to affix the device to the workpiece door.

Priority claimed to provisional 60/608,731

### FIELD OF INVENTION

This invention is concerned with devices that move or open the drapes of patio doors. More specifically the present invention is concerned with devices that open the drapes with the same motion that opens the sliding doors. The present mention in a square hook with a roller to move the drapes aside as the sliding door is opened thus allowing convenient and ready access through sliding doors to and from a patio or other outside areas.

### BACKGROUND OF INVENTION

Large glass doors that open by sliding are common features of American houses. These large glass doors allow a view of the outside. Commonly, they open onto deck or patio areas. However, since these doors are typically made with clear glass they can allow casual strangers to look inside the house. So typically the house owners will open the curtains or drapes during daylight hours or other times that they wish to see into or out of the patio doors. In most instances, the drapes will be extended to cover the glass door(s). Likewise, closed or extended drapes reduce air conditioning and heating bills.

The extended drapes that cover the door of the access opening can create a nuisance. That is, the sliding door that opens the drapes must be pushed aside to allow entrance or egress. This creates a minor hazard when using the glass doors. In addition, manual pushing of the drapes causes stains on the drapes as well as potential damage to the suspension hooks which suspend the drapes from a curtain rod.

### SUMMERY OF INVENTION

The drapery opener hook device is made of a journal with an attachment end and a hook end. The attachment end is affixed with squeeze pressure points to a flat attachment base. The flat attachment base, in turn, is affixed to the workpiece door. The hook end of the journal has a first bend and a second bend to create a square base hook. A second bend creates a hook end. The square base hook has a rotational sleeve with one or more independent sections to allow the ready movement of the drape over said square base hook. The attachment base has holes to receive screws and pressure points as attachment means to attach the journal to the flat attachment base. The attachment base has holes to receive screws to affix the invention to a workpiece door.

### BRIEF DESCRIPTION OF FIGURES

FIG. 1 shows a perspective of the isolated drapery opener hook.

FIG. 2 shows a top view the drapery opener hook.

FIG. 3 shows a section of a glass sliding door with the drapery opener hook attached.

FIG. 4 illustrates a doorframe showing in the outline is first sliding door with drapes.

FIG. 5 shows the drapery opener hook end as the door handle moves first sliding door.

FIG. 6 shows an uncluttered perspective view of the drapery opener hook device

### DETAILED DESCRIPTION OF THE FIGURES

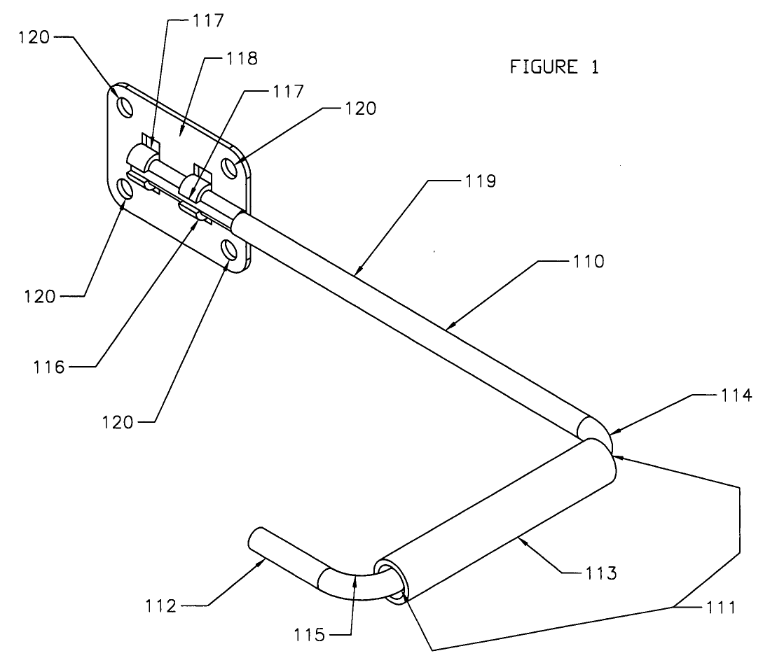

FIG. 1 shows the square U-shaped hook drapery opener hook device 110. Drapery opener device 110 has a square base 111 to make a hook. First bend 114 creates square base of hook 111. A second bend 115 connects hook base 111 and hook end 112. Attachment end 116 of drapery opener 110 is attached to flat attachment base 118. Flat attachment base 118 has squeeze pressure points 117 to attach the journal 119 of hook opener 110 to attachment base 118. Holes 120 in flat attachment base 118 provide openings such that screws or other attachment means can affix attachment plate 118 to the workpiece doors. Roller 113 provides a rotational sleeve to allow the ready movement of the drape over the square 111 base of hook 110. Likewise, rotational sleeve 113 may have 2 or more partial cylinders 333.

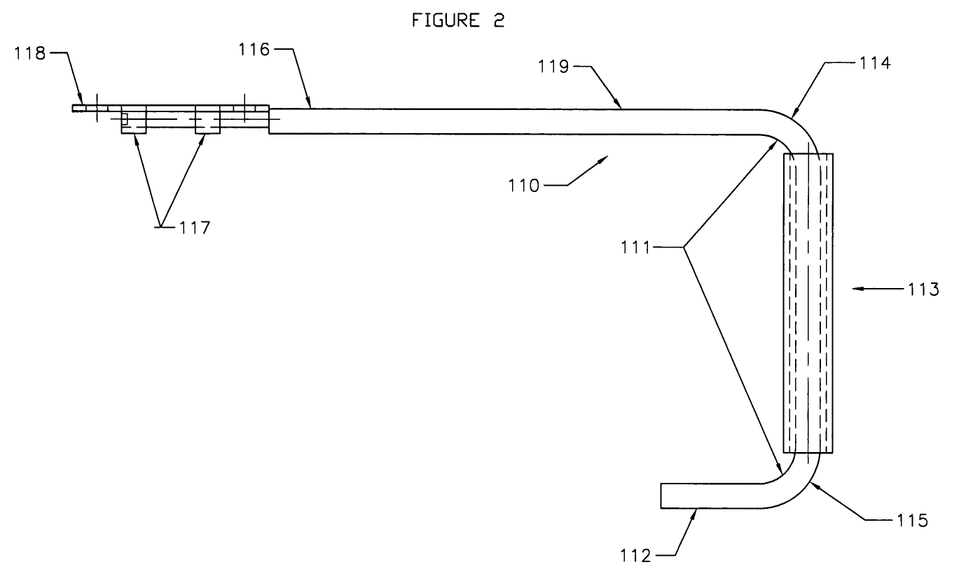

FIG. 2 shows a top view the drapery opener hook device 110. Top view of drapery opener 110 has a square base 111. First bend 114 creates a square base of hook 111. A second bend 115 connects hook base 111 to hook end 112. Attachment end 116 of drapery opener 110 is attached to flat attachment base 118. Flat attachment base 118 has squeeze pressure points 117 to attach the journal 119 of hook 110 to attachment base 118. Roller 113 provides a rotational sleeve to allow the ready movement of the drape over the square base of hook 111.

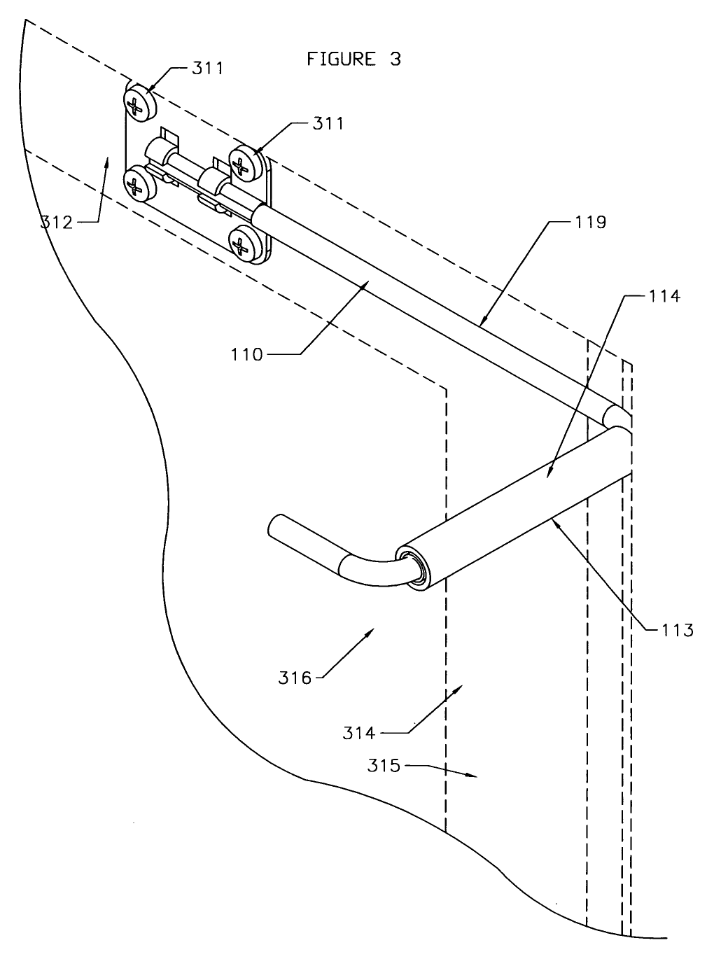

FIG. 3 shows perspective of U-shaped drapery opener hook device 110 attached to the work piece doorframe 314. Roller 113 is connected journal 119 which in turn is attached to flat attachment base 118. Screws 311 attach device 110 to upper part 312 of doorframe 314. Doorframe side 315 and upper part 312 hold door glass 316

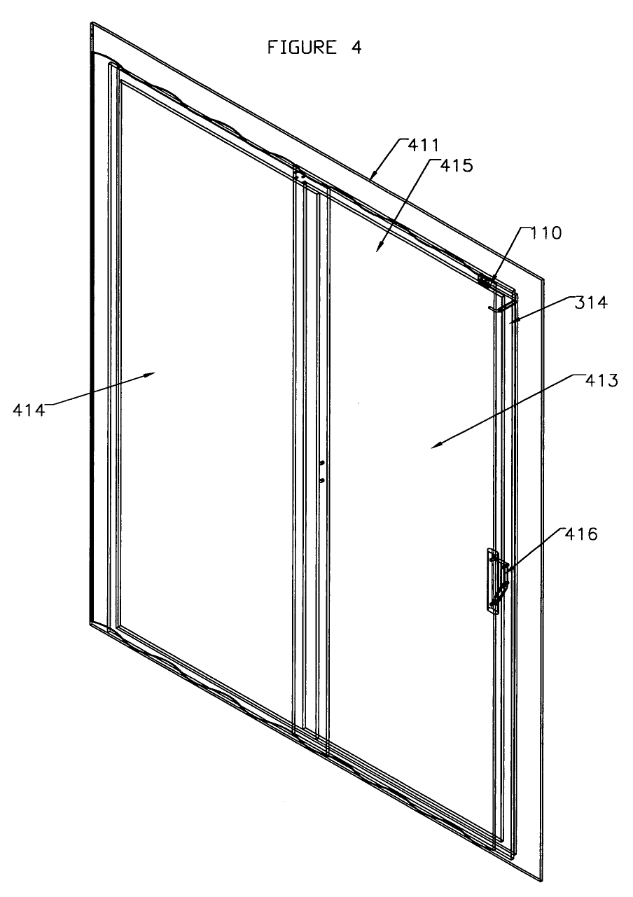

FIG. 4 illustrates a doorframe 411 showing in outline first sliding door 413 second sliding door 414 is shown. Hook drapery opener 110 is attached to the upper part 312 of the doorframe 314. FIG. 4 illustrates that the drapes (a workpiece) 415 cover for sliding door 413 and second sliding door for 414. Handle 416 is shown.

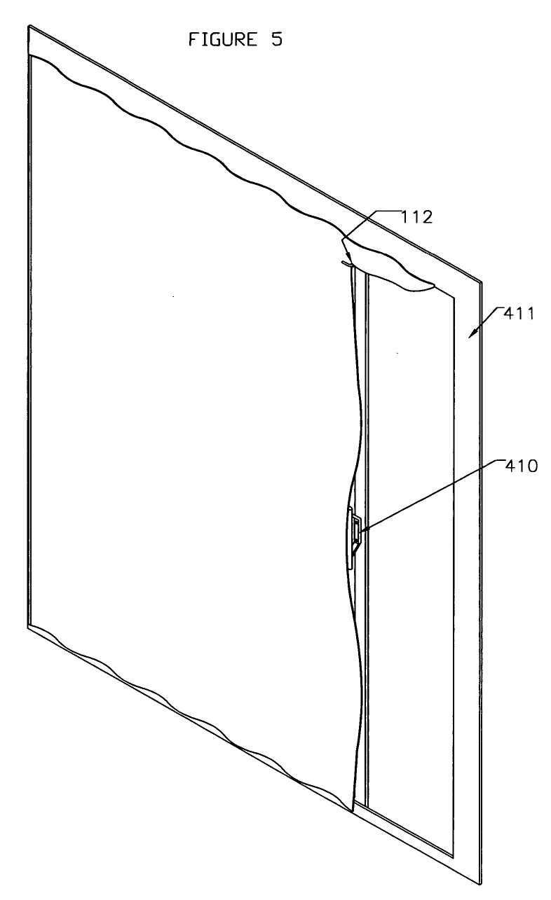

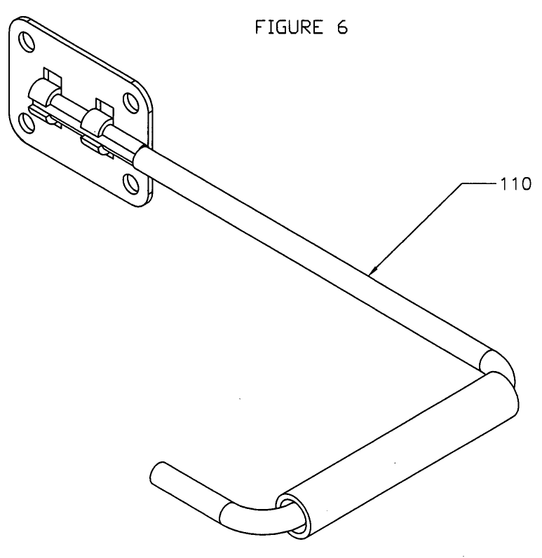

FIG. 5 shows the drapery opener hook end 112 as the door handle 416 moves first sliding door 413. Drapery workpiece 415 is moved aside as first sliding door 413 is opened. FIG. 6 shows an uncluttered perspective view of the drapery hook opener.

FIG. 6 shows an uncluttered perspective view of the drapery opener hook device 110. It is shown uncluttered to illustrate squeeze pressure points 117 which attach the device to attachment base 118. Note that squeezed pressure points 117 allows a detachment means so that the hook 110 can be detached and from the attachment base 118 in case the drapery somehow catches. While squeeze pressure points 117 provide a ready detachment means other detached means are known to the art. Of course a ready detachment means it is recommended for the drapery hook opener 110 in case the drape is “caught” and may be damaged is the movement of the drapery over roller 113 is forced. In this contingency the hook journal 119 with roller 113 will disconnect from the attachment base 118.

I claim:

1) A drapery opener hook device comprising:
a journal with an attachment end and a hook end;
said attachment end is affixed with squeeze pressure points to a flat attachment base;
said flat attachment base is affixed to the workpiece door;
said hook end has a first bend and a second bend to create a square base hook;
said second bend creates a hook end;
said square base hook has a rotational sleeve to allow the ready movement of the drape over said square base hook.

2) A drapery opener hook device as in 1) wherein said attachment base has holes to receive screws.

3) A drapery opener hook device as in 1) wherein said affixment means is by pressure points.

4) A drapery opener hook device as in 1) wherein said attachment base is flat.

5) A drapery opener hook device as in 1) wherein said rotational sleeve has several independent sections.

6) A drapery opener hook device as in 1) wherein journal can detach from said attachment base in case the drape is “caught.”

7) A drapery opener hook device as in 1) wherein said attachment base has holes to receive screws to affix said device to workpiece door.
